(19) United States
(12) Patent Application Publication
(10) Pub. No.: US 2021/0088985 A1
(43) Pub. Date: Mar. 25, 2021

(54) MACHINE LEARNING DEVICE, MACHINE LEARNING METHOD, AND MACHINE LEARNING PROGRAM

(71) Applicant: KONICA MINOLTA, INC., Tokyo (JP)

(72) Inventors: SHUN SUGAI, Tokyo (JP); KOICHI SAITO, Toyohashi-shi (JP)

(73) Assignee: KONICA MINOLTA, INC., Tokyo (JP)

(21) Appl. No.: 16/991,088

(22) Filed: Aug. 12, 2020

(30) Foreign Application Priority Data
Sep. 19, 2019 (JP) 2019-170259

(51) Int. Cl. G05B 13/02; G06N 20/00; G06N 3/08; G03G 15/00

(52) U.S. Cl. CPC G05B 13/0265; G06N 20/00; G06N 3/08; G03G 15/5045; G03G 15/5041; G03G 15/5037; G03G 15/5029

(57) ABSTRACT

A machine learning device generates a control parameter of image formation in an image forming device including an image forming part that forms an image on a paper sheet and an image reading part that reads the image formed on the paper sheet, and the machine learning device includes: a first hardware processor that generates the control parameter on the basis of machine learning; a second hardware processor that receives input of an image including a read image that is formed by the image forming part according to the control parameter and read by the image reading part, the second hardware processor making a determination relating to the read image on the basis of machine learning; and a third hardware processor that causes the first hardware processor and/or the second hardware processor to learn oil the basis of a determination result by the second hardware processor.

The entire disclosure of Japanese patent Application No. 2019-170259, filed on Sep. 19, 2019, is incorporated herein by reference in its entirety.

### BACKGROUND

### Technological Field

The present invention relates to a machine learning device, a machine learning method, and a machine learning program, and more particularly to a machine learning device, a machine learning method, and a machine learning program that generate a control parameter of image formation in an image forming device.

### Description of the Related art

Image forming devices such as multi-functional peripherals (MFPs) are required to provide output products that meet the needs of users. Image quality is one of the needs of the users. However, a parameter that controls image formation in an image forming device (hereinafter referred to as a control parameter) is designed according to a machine state assumed in a development stage, and therefore it is not possible to cover all machine states in the market. As a result, image quality desired by the users may not be obtained in an unexpected machine state.

Regarding such control parameter, for example, JP 2017-034844 A discloses a configuration in which in an image forming device including an image carrier, a developer carrier, a developer supply member, a first voltage applying means, a second voltage applying means, and a control means, when an absolute value of a velocity difference between a peripheral velocity of the image carrier and a peripheral velocity of the developer carrier is S, the smaller S is, the more the control means is configured to shift a difference Vdif (=Vrs−Vdr) between Vrs and Vdr to a direction of a polarity opposite to a normal charged polarity. The image carrier rotates while carrying an electrostatic latent image. The developer carrier rotates at a constant peripheral velocity ratio with respect to the image carrier while carrying developer and develops the electrostatic latent image. The developer supply member has a foam layer on a surface thereof, is disposed in contact with the developer carrier, rotates at a constant peripheral velocity ratio with respect to the developer carrier in a direction opposite to a rotation direction of the developer carrier, and supplies the developer to the developer carrier. The first voltage applying means applies a voltage Vdr to the developer carrier. The second voltage applying means applies a voltage Vrs to the developer supply member. The control means controls the first voltage applying means and second voltage applying means.

In order to be able to obtain the image quality desired by the users, it is necessary to create software that constantly monitors the state of the image forming device and individually controls a machine (generates a control parameter) according to the state. As a means to achieve such software, reinforcement learning can be mentioned. The reinforcement learning is a type of unsupervised learning in which it is determined whether control (action) performed in a certain machine state is good or bad, a reward is given, and learning is performed without a teacher in a set of the state and the action on the basis of the reward.

However, it is difficult to evaluate control performed by various image forming devices in the market and design the software. For example, when a toner density, a positional deviation, image quality, and the like are within reference values at a development stage, it is possible to determine that those control parameters are good, but it is difficult for a machine in the market to evaluate such control parameters.

### SUMMARY

The present invention has been made in view of the above problems, and a main object of the present invention is to provide a machine learning device, a machine learning method, and a machine learning program capable of appropriately generating a control parameter in image formation.

To achieve the abovementioned object, according to an aspect of the present invention, there is provided a machine learning device that generates a control parameter of image formation in an image forming device including an image forming part that forms an image on a paper sheet and an image reading part that reads the image formed on the paper sheet, and the machine learning device reflecting one aspect of the present invention comprises: a first hardware processor that generates the control parameter on the basis of machine learning; a second hardware processor that receives input of an image including a read image that is formed by the image forming part according to the control parameter and read by the image reading part, the second hardware processor making a determination relating to the read image on the basis of machine learning; and a third hardware processor that causes the first hardware processor and/or the second hardware processor to learn on the basis of a determination result by the second hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing a configuration of a control system according to one embodiment of the present invention;

FIG. 2 is a schematic diagram showing another configuration of the control system according to the one embodiment of the present invention;

FIGS. 3A and 3B are block diagrams showing a configuration of a machine learning device according to the one embodiment of the present invention;

FIGS. 4A and 4B are block diagrams showing a configuration of an image forming device according to the one embodiment of the present invention;

FIG. 5 is a schematic diagram showing a processing flow of the control system according to the one embodiment of the present invention;

FIG. 6 is a flowchart diagram showing a learning flow in the machine learning device according to the one embodiment of the present invention;

FIGS. 7A and 7B are tables for describing a learning method in the machine learning device according to the one embodiment of the present invention;

FIG. 8 is a schematic diagram showing an outline of learning in a generator of the machine learning device according to the one embodiment of the present invention;

FIG. 9 is a schematic diagram showing an outline of an image forming part of the image forming device according to the one embodiment of the present invention;

FIG. 10 is a flowchart diagram showing processing of the generator of the machine learning device according to the one embodiment of the present invention;

FIGS. 11A and 11B are graphs showing a relationship between an image density and a potential difference or a sub-hopper toner remaining amount in image formation;

FIG. 12 is a flowchart diagram showing the processing of the generator of the machine learning device according to the one embodiment of the present invention (in a case where the sub-hopper toner remaining amount is input);

FIG. 13 is a schematic diagram showing a processing flow of the control system according to the one embodiment of the present invention;

FIG. 14 is a flowchart diagram showing the operation of the control system according, to the one embodiment of the present invention;

FIG. 15 is a flowchart diagram showing the operation (first learning control) of the control system according to the one embodiment of the present invention;

FIG. 16 is a flowchart diagram showing the operation (second earning control) of the control system according to the one embodiment of the present invention;

FIG. 17 is a flowchart diagram showing the operation (third learning control) of the control system according to the one embodiment of the present invention; and

FIG. 18 is a flowchart diagram showing the operation (fourth learning control) of the control system according to the one embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

As shown in Description of the Related art, a control parameter that controls image formation in an image forming device is designed according to a machine state assumed in a development stage. Therefore, it may not be possible to cover all machine states in the market, and it may not be possible to obtain image quality desired by a user in an unexpected machine state. In order to be able to obtain the image quality desired by the user, it is necessary to create software that constantly monitors a state of the image forming device and individually controls a machine according to the state. As a means to achieve the software, reinforcement learning can be mentioned.

However, it is difficult to evaluate control perforated by various image forming devices in the market and design the software. For example, When a toner density, positional deviation, image quality, and the like are within reference values at the development stage, it is possible to determine that those control parameters of image formation are good, but it is difficult to evaluate such image forming control parameters by a machine in the market.

Therefore, in one embodiment of the present invention, machine learning of artificial intelligence (AI) (particularly reinforcement learning) is used, an image reading part 41 such as an image calibration control unit (ICCU) capable of reading an image formed on a paper sheet is used to input an image including an image (referred to as a read image) that is formed according to a control parameter and read, a determination relating to the read image is made on the basis of machine learning, and learning is performed on the basis of a determination result (for example, a determination is made as to whether the input image is either the read image or an image prepared in advance (referred to as a comparison image), and learning is performed on the basis of a determination result). As a result, the reinforcement learning of the control parameter is achieved. At that time, learning accuracy is improved by causing a generator and a discriminator to learn adversarially. The generator is configured to generate the control parameter, and the discriminator is configured to determine whether the read image and the comparison image match each other.

In this way, the reinforcement learning is applied to the generation of the control parameter of image formation, whereby it becomes possible to generate a control parameter according to each machine in the market, and to satisfy a requirement of the user who uses each machine (image quality and the like desired by the user).

### Embodiments

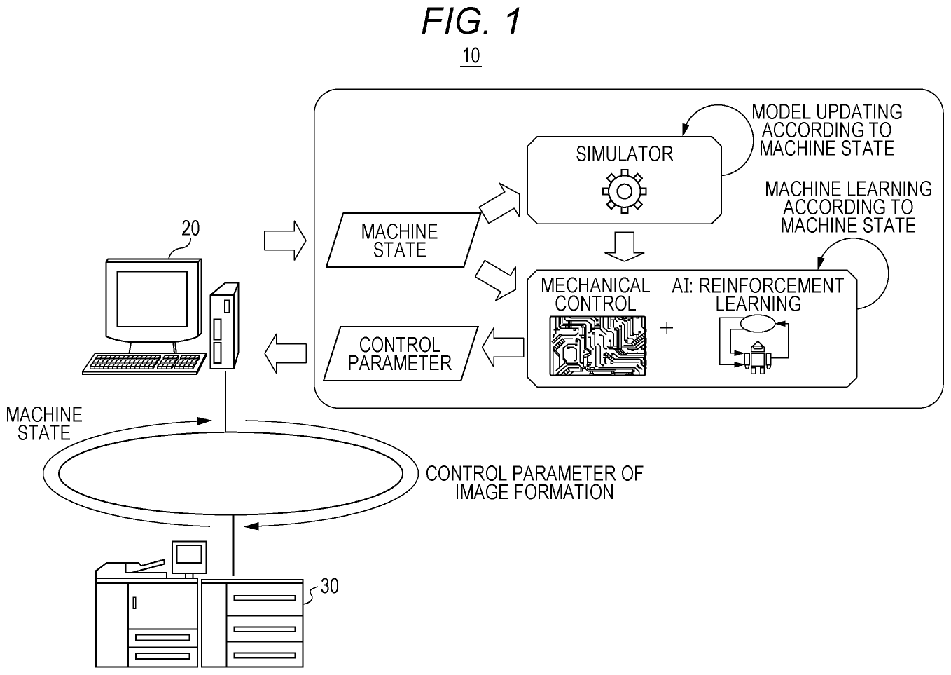

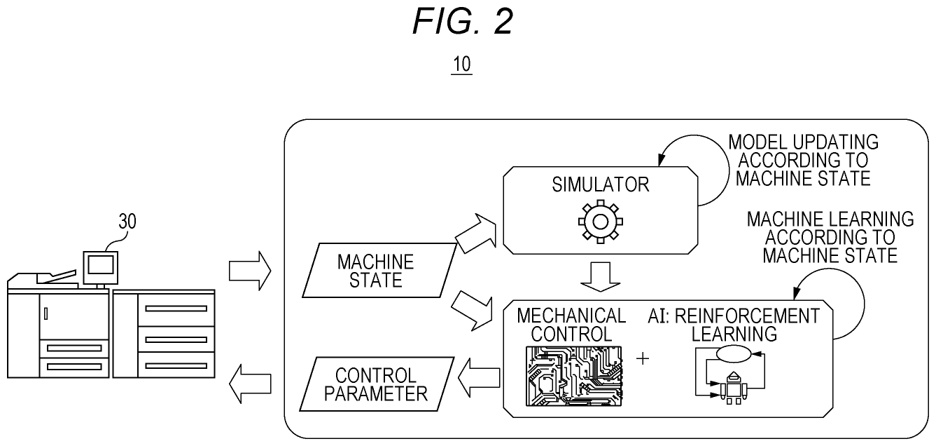

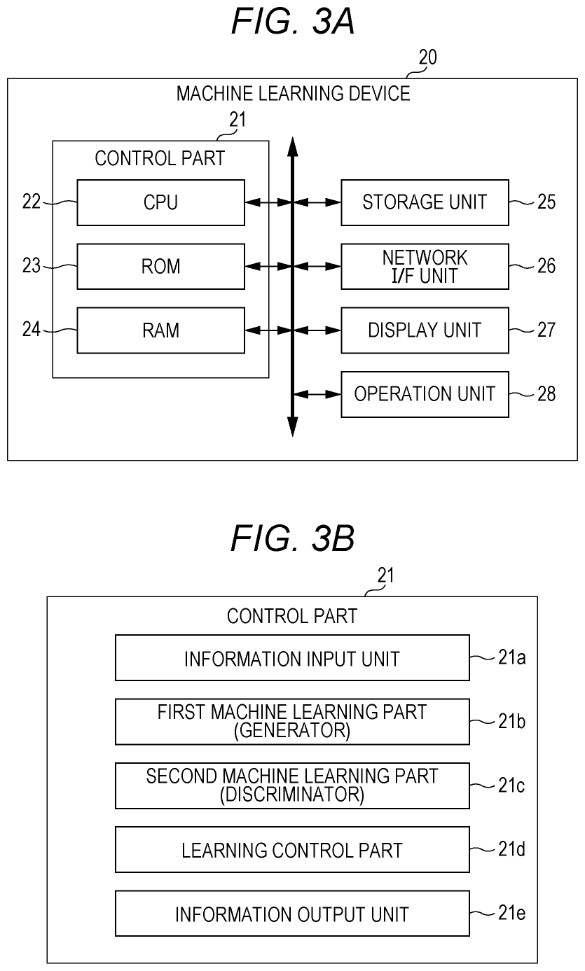

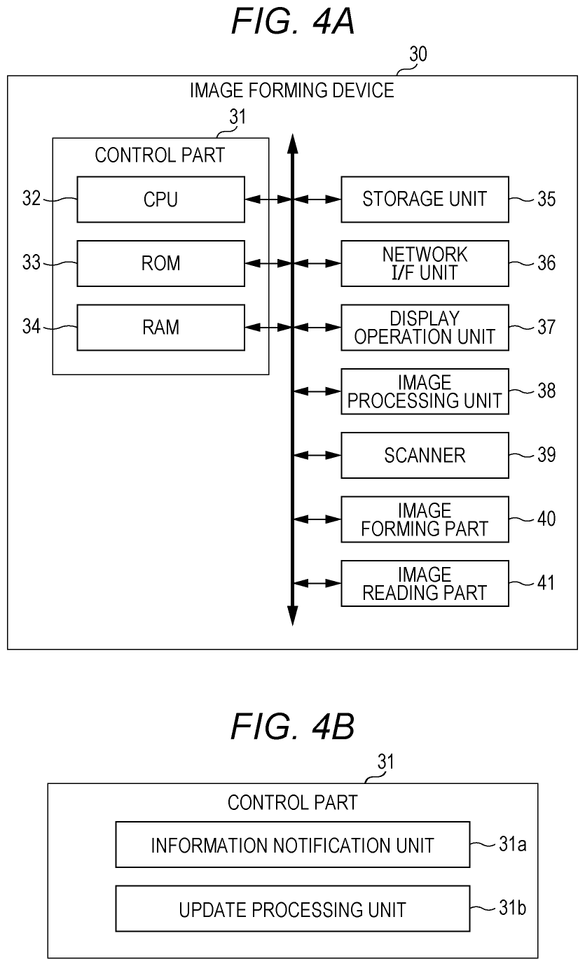

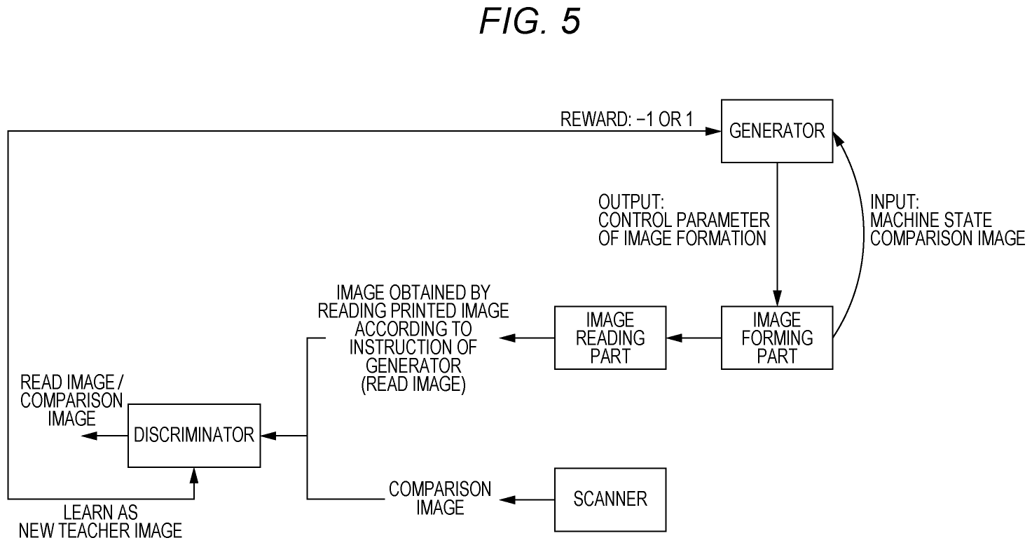

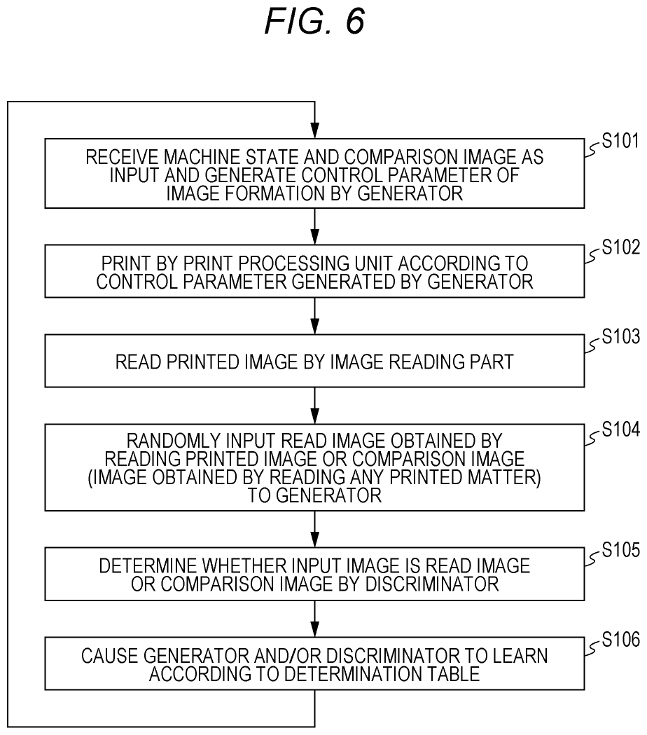

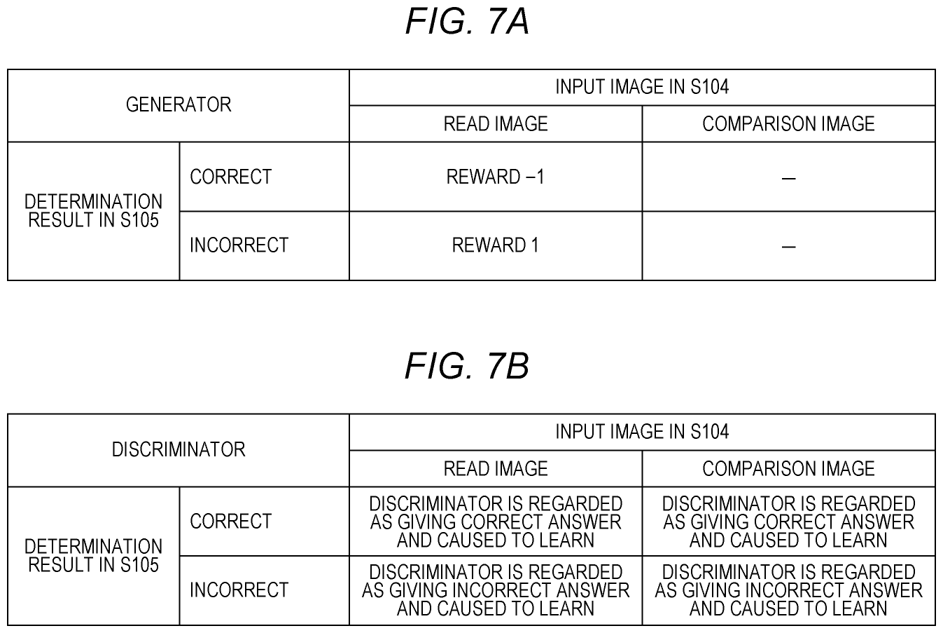

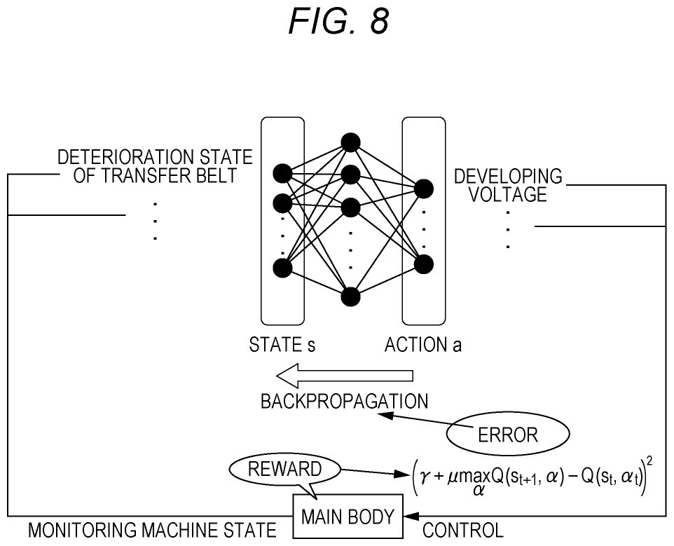

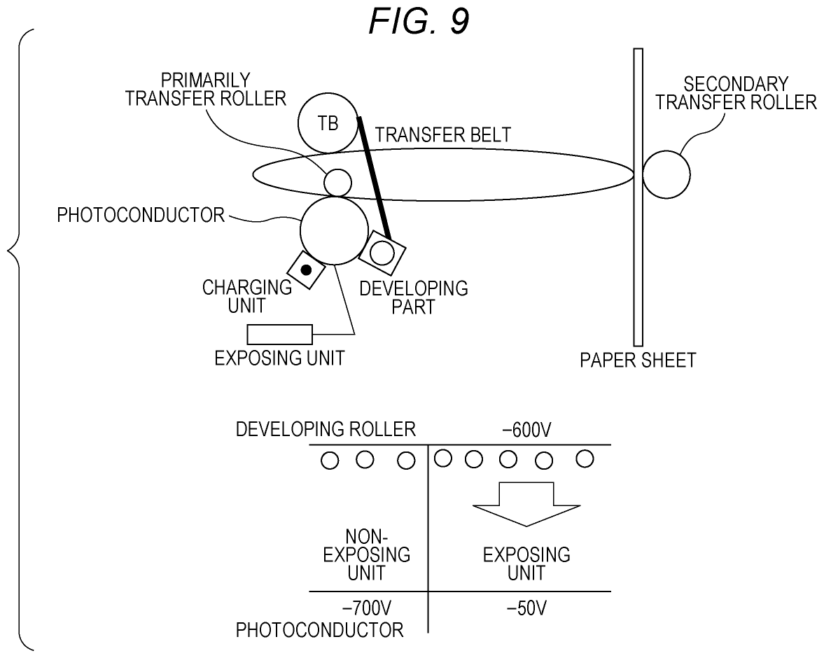

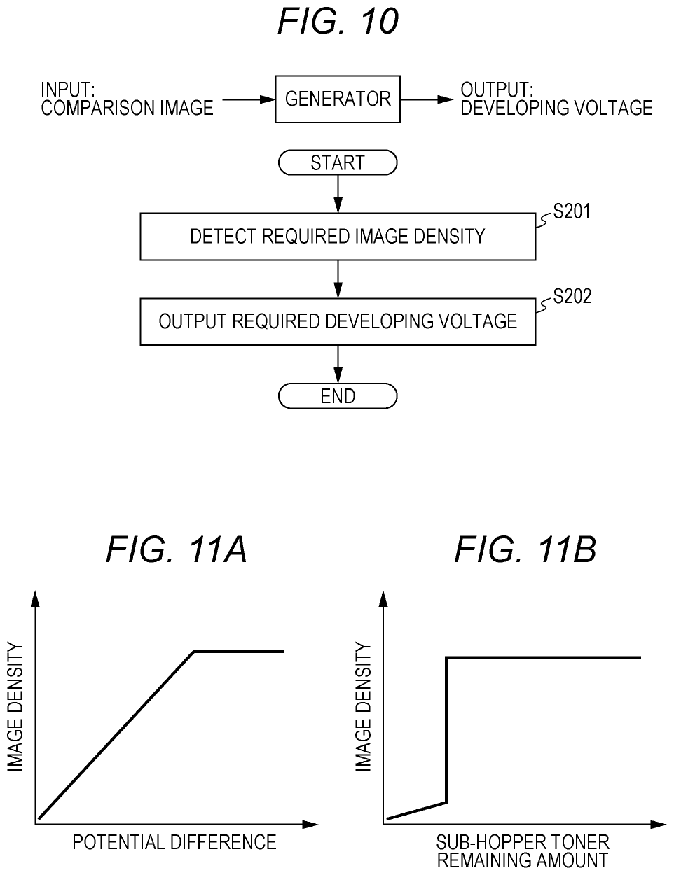

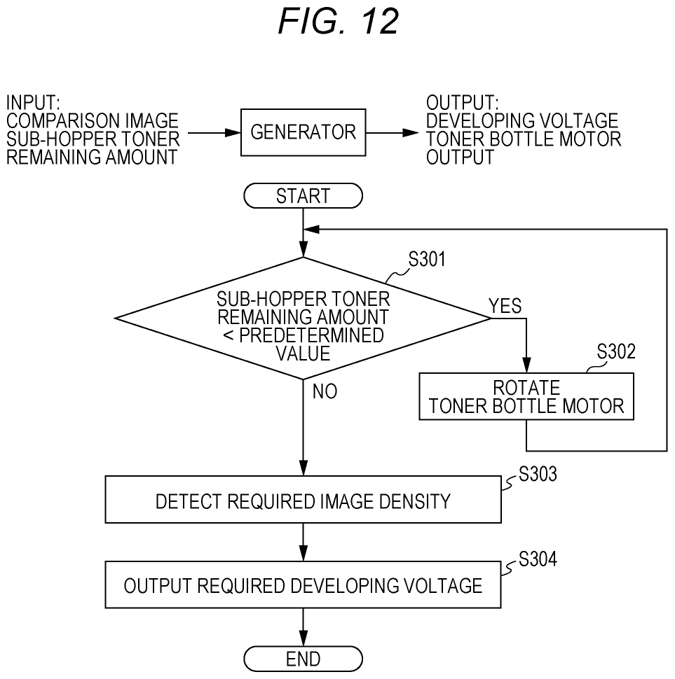

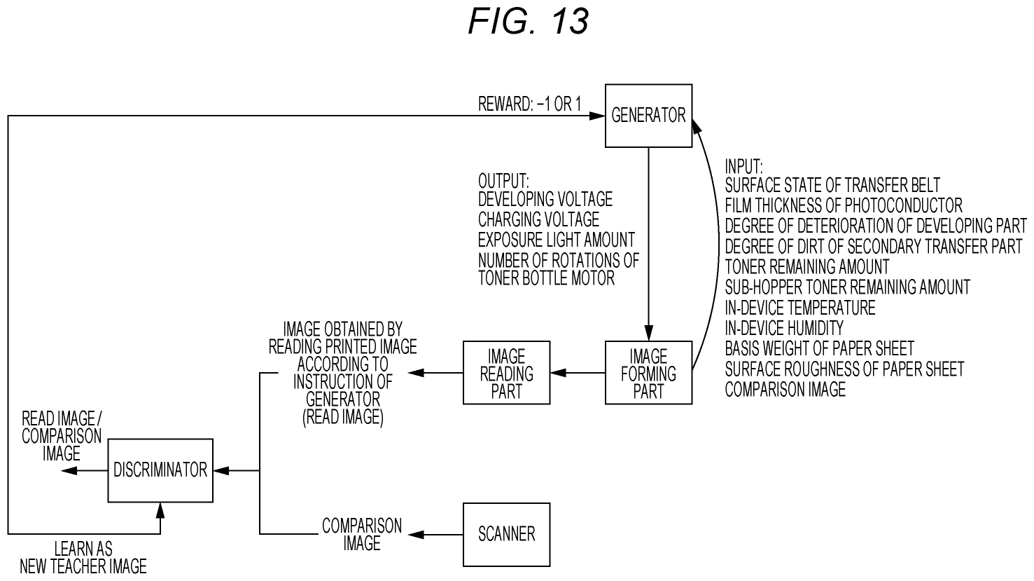

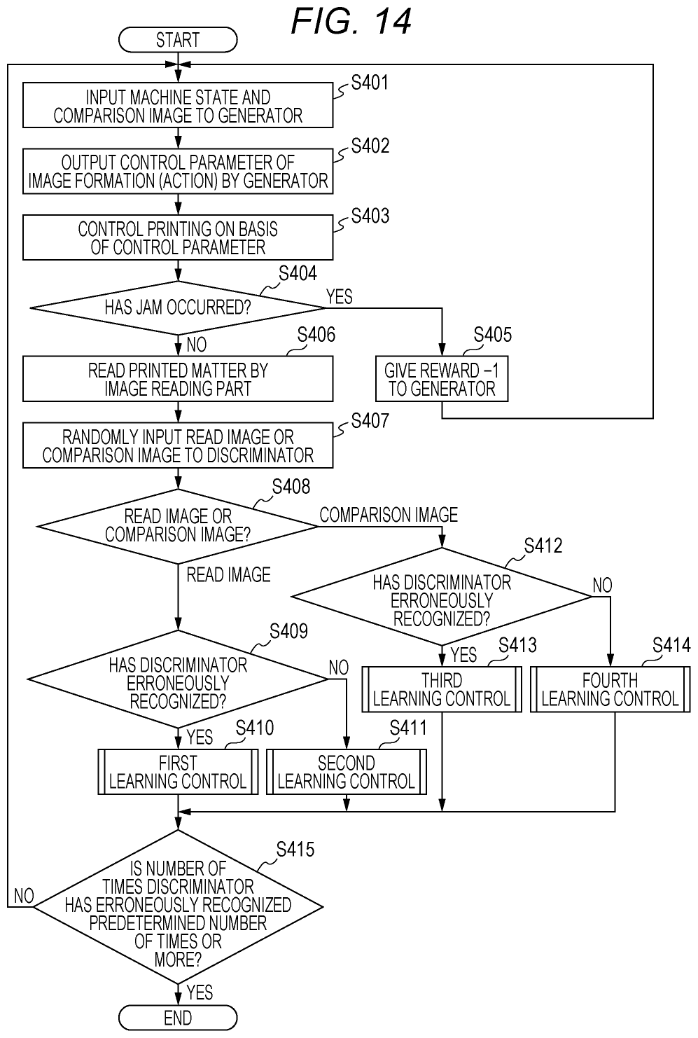

In order to describe the one embodiment of the present invention described above in more detail, a machine learning device 20, a machine learning method, and a machine learning program according to the one embodiment of the present invention will be described with reference to FIGS. 1 to 18. FIGS. 1 and 2 are schematic diagrams showing configurations of a control system 10 of the present embodiment. FIGS. 3A and 3B and FIGS. 4A and 4B are block diagrams show configurations of the machine learning device 20 and an image forming device 30 of the present embodiment, respectively. Furthermore, FIG. 5 is a schematic diagram showing a processing flow of the control system 10 of the present embodiment, and FIG. 6 is a flowchart diagram showing a learning flow in the machine learning device 20 of the present embodiment. Furthermore, FIGS. 7A and 7B are tables for describing the learning method in the machine learning device 20 of the present embodiment, and FIG. 8 is a schematic diagram showing an outline of learning in a generator of the machine learning device 20 of the present embodiment. Furthermore, FIG. 9 is a schematic diagram showing an outline of an image forming part 40 of the image forming device 30 of the present embodiment, and FIG. 10 is a flowchart diagram showing the operation of the generator of the machine learning device 20 of the present embodiment. Furthermore, FIGS. 11A and 11B are graphs showing a relationship between an image density and a potential difference or a sub-hopper toner remaining amount in image formation, and FIG. 12 is a flowchart diagram showing the operation of the generator of the machine learning device 20 of the present embodiment. Furthermore, FIG. 13 is a schematic diagram showing a processing flow of the control system 10 of the present embodiment, and FIGS. 14 to 18 are flowchart diagrams showing the operation of the control system 10 of the present embodiment.

First, the configuration and control of the control system 10 of the present embodiment will be outlined. As shown in FIG. 1, the control system 10 of the present embodiment includes the machine learning device 20 configured to execute a cloud service that generates the control parameter of image formation as a cloud server (see the frame in the figure) and an image forming device 30 configured to form an image according to the generated control parameter. The machine learning device 20 and the image forming device 30 are connected to each other via a communication network such as a local area network (LAN) and, a wide area network (WAN) specified by Ethernet (registered trademark), token ring, and fiber-distributed data interface (FDDI).

In the control system 10 of FIG. 1, when it is determined that the image forming device 30 (edge side) of the user needs learning, a machine state of the image forming device 30 is notified to the machine learning device 20 (cloud side), and learning is started to generate a control parameter that provides image quality that satisfies the requirement of the user in a current machine state. On the cloud side, it is possible to accelerate a learning speed by simulating the machine on the basis of the machine state notified from the edge side and learning by a simulator. Then, after the simulator completes the learning, a control parameter for applying a learning model to the machine is returned to the edge side, whereby it is possible to print with an updated learning model (appropriate control parameter) also in the image forming device 30 of the user.

Note that although FIG. 1 shows a case where the machine learning is performed on the cloud side (in the machine learning device 20), as shown in FIG. 2, it is also possible to execute a service equivalent to the cloud service of the cloud server (see inside of the frame) on the edge side (in the image forming device 30 or a control device configured to control the image forming device 30). In that case, there is downtime during which the image forming device 30 cannot perform printing or the like while performing the machine learning, but in a case where the accuracy of the simulator is not sufficient (the machine state of the image forming device 30 on the edge side cannot be accurately simulated), more accurate machine learning becomes possible. Hereinafter, each device will be described in detail on the premise of the system configuration in FIG. 1.

[Machine Learning Device]

The machine learning device 20 is a computer device configured to generate the control parameter of image formation, and as shown in FIG. 3A, includes a control part 21, a storage unit 25, and a network I/F unit 26, and, as necessary, a display unit 27, an operation unit 28, and the like.

The control part 21 includes a central processing unit (CPU) 22 and memories such as a read only memory (ROM) 23 and a random access memory (RAM) 24. The CPU 22 is configured to expand a control program stored in the ROM 23 and the storage unit 25 into the RAM 24 and execute the control program, thereby controlling the operation of the whole of the machine learning device 20. As shown in FIG. 3B, the above control part 21 is configured to function as an information input unit 21a, a first machine learning part 21b, a second machine learning part 21c, a learning control part 21d, an information output unit 21e, and the like.

The information input unit 21a is configured to acquire data of the machine state and the comparison image from the image forming device 30. Furthermore, the information input unit 21a is configured to acquire, from the image forming device 30, data of an image (read image) obtained by reading an image formed according to the control parameter. The above machine state includes, for example, a surface state of a transfer belt, a film thickness of a photoconductor, a degree of deterioration of a developing part, a degree of dirt of a secondary transfer part, a toner remaining amount, the sub-hopper toner remaining amount, in-device temperature, in-device humidity, and a basis weight of the paper sheet, surface roughness of the paper sheet. Furthermore, the comparison image is an image formed on any printed matter, an image obtained by reading any printed matter, or the like, and is used when the image forming device 30 forms an image according to the control parameter as necessary.

The first machine learning part 21b (referred to as a generator) is configured to receive input of the machine state and the comparison image described above, and generate and output a control parameter of image formation on the basis of the machine learning. At that time, in a case where the first machine learning part 21b receives input of the comparison image, the first machine learning part 21b is capable of generating a control parameter by reinforcement learning using a neural network. In a case where the first machine learning part 21b receives input of the machine state, the first machine learning part 21b is capable of generating a control parameter by reinforcement learning using a convolutional neural network. The above control parameters are, for example, a developing voltage, a charging voltage, an exposure light amount, and the number of rotations of a toner bottle motor.

The second machine learning part 21c (referred to as a discriminator) is configured to receive input of an image including the above read image and make a determination relating to the read image on the basis of machine learning. For example, by image distinction using deep learning, the second machine learning part 21c is configured to determine whether the input image is the read image obtained by reading an image formed on the paper sheet according to the control parameter (whether the input image is the read image or the comparison image).

The learning control part 21d is configured to cause the first machine learning part 21b and/or the second machine learning part 21c to learn on the basis of a determination result by the second machine learning, part 21c. For example, the learning control part 21d is configured to randomly input either one of the read image and the comparison image to the second machine learning part 21c, give a reward to the first machine learning part 21b, and cause the second machine learning part 21c to learn on the basis of whether the second machine learning part 21c has been able to discriminate the input image.

Specifically, when the read image is input to the second machine learning part 21c, in a case where the second machine learning part 21c has determined that the input image is the read image, the learning control part 21d is configured to give a negative reward to the first machine learning part 21b, regard the second machine learning part 21c as giving a correct answer, and cause the second machine learning part 21c to learn (give a positive reward). Furthermore, when the read image is input to the second machine learning part 21c, in a case where the second machine learning part 21c has determined that the input image is the comparison image, the learning control part 21d is configured to give a positive reward to the first machine learning part 21b, regard the second machine learning part 21c as giving an incorrect answer, and cause the second machine learning part 21c to learn (give a negative reward). Furthermore, when the comparison image is input to the second machine learning part 21c, in a case where the second machine learning part 21c has determined that the input image is the comparison image, the learning control part 21d is configured to not give a reward to the first machine learning part 21b and to regard the second machine learning part 21c as giving a correct answer and cause the second machine learning part 21c to learn (give a positive reward). Furthermore, when the comparison image is input to the second machine learning part 21c, in a case where the second machine learning part 21c has determined that the input image is the read image, the learning control part 21d is configured to not give a reward to the first machine learning part 21b and to regard the second machine learning part 21c as giving an incorrect answer and cause the second machine learning part 21c to learn (give a negative reward).

The learning of the first machine learning part 21b and/or the second machine learning part 21c described above can be performed after printing is performed on a predetermined number of paper sheets or when the machine state of the image forming device 30 has changed by a predetermined value or more. In a case where the read image is input to the second machine learning part 21c, when the number of times the second machine learning part 21c has determined (erroneously recognized) that the input image is the comparison image reaches a predetermined number of times or more, the learning can be ended.

The information output unit 21e is configured to output the control parameter generated by the first machine learning part 21b to the image forming device 30. Furthermore, the information output unit 21e is configured to create update information that updates firmware of the image forming device 30 on the basis of a learning result and output the update information to the image forming device 30.

The information input unit 21a, the first machine learning part 21b, the second machine learning part 21c, the learning control part 21d, the information output unit 21e described above may be configured as hardware or may be configured as a machine learning program that causes the control part 21 to function as the information input unit 21a, the first machine learning part 21b, the second machine learning part 21c, the learning control part 21d, the information output unit 21e (especially, the first machine learning part 21b, the second machine learning part 21c, and the learning control part 21d) and the CPU 22 may be caused to execute the machine learning program.

The storage unit 25 includes a hard disk drive (HDD), a solid state drive (SSD), and the like, and is configured to store a program for the CPU 22 to control each part and unit, the machine state and the comparison image acquired from the image forming device 30, the read image, the control parameter generated by the first machine learning part 21b, and the like.

The network I/F unit 26 includes a network interface card (NIC), a modem and the like, and is configured to connect the machine learning device 20 to the communication network and establish a connection with the image forming device 30.

The display unit 27 includes a liquid crystal display (LCD), an organic electroluminescence (EL) display, and the like, and is configured to display various screens.

The operation unit 28 includes a mouse, a keyboard, and the like, is provided as necessary, and is configured to enable various operations.

[Image Forming Device]

The image forming device 30 is an MFP or the like configured to form an image according to a control parameter of image formation, and as shown in FIG. 4A, includes a control part 31, a storage unit 35, a network I/F unit 36, a display operation unit 37, an image processing unit 38, a scanner 39, the image forming part 40, the image reading part 41, and the like.

The control part 31 includes a CPU 32 and memories such as a ROM 33 and a RAM 34. The CPU 32 is configured to expand a control program stored in the ROM 33 and the storage unit 35 into the RAM 34 and execute the control program, thereby controlling operation of the whole of the image forming device 30. As shown in FIG. 4B, the above control part 31 is configured to function as an information notification unit 31a, an update processing unit 31b, and the like.

The information notification unit 31a is configured to acquire the machine state (the surface state of the transfer belt, the film thickness of the photoconductor, the degree of deterioration of the developing part, the degree of dirt of the secondary transfer part, the toner remaining amount, the sub-hopper toner remaining amount, the in-device temperature, the in-device humidity, and the basis weight of the paper sheet, the surface roughness of the paper sheet, and the like) on the basis of the information acquired from each part and unit of the image forming part 40 and notify the machine learning device 20 of the acquired machine state. Furthermore, the information notification unit 31a is configured to notify the machine learning device 20 of a comparison image obtained by reading any printed matter by the scanner 39 or a read image obtained by forming an image by the image forming part 40 according to the control parameter received from the machine learning device 20 and reading the image by the image reading part 41.

The update processing unit 31b is configured to acquire the update information for updating the firmware according to the learning model from the machine learning device 20, and update the firmware configured to control each part and unit of the image forming part 40 (generate the control parameter of image formation) on the basis of the update information. At that time, the firmware may be updated every time the update information is acquired from the machine learning device 20, or the firmware may be collectively updated after acquiring a plurality of update information.

The storage unit 35 incudes a HDD, an SSD, and the like, and is configured to store a program for the CPU 32 to control each part and unit, information relating to a processing function of the image forming device 30, the machine state, the comparison image, the read image, the control parameter and the update information acquired from the machine learning device 20, and the like.

The network I/F unit 36 includes an NIC, a modem, and the like, and is configured to connect the image forming device 30 to the communication network and establish communication with the machine learning device 20 and the like.

The display operation unit (operation panel) 37 is, for example, a touch panel provided with a pressure-sensitive or capacitance-type operation unit (touch sensor) in which transparent electrodes are arranged in a grid on a display unit. The display operation unit 37 is configured to display various screens relating to print processing and enable various operations relating to the print processing.

The image processing unit 38 is configured to function as a raster image processor (RIP) unit, translate a print job to generate intermediate data, and perform rendering to generate bitmap image data. Furthermore, the image processing unit 38 is configured to subject the image data to screen processing, gradation correction, density balance adjustment, thinning, halftone processing, and the like as necessary. Then, the image processing unit 38 is configured to output the generated image data to the image forming part 40.

The scanner 39 is a part configured to optically read image data from a document placed on a document table, and includes a light source configured to scan the document, an image sensor configured to convert light reflected by the document into an electric signal such as a charge coupled device (CCD), an analog-to-digital (A/D) converter configured to subject the electric signal to an A/D conversion, and the like.

The image forming part 40 is configured to execute the print processing on the basis of the image data acquired from the image processing unit 38. The image forming part 40 includes, for example, a photoconductor drum, a charging unit, an exposing unit, a developing part, a primary transfer unit, a secondary transfer part, a fixing unit, a paper sheet discharging unit, and a transporting unit, and the like. A photoconductor is formed in the photoconductor drum. The charging unit is configured to charge the surface of the photoconductor drum. The exposing unit is configured to form an electrostatic latent image based on the image data on the charged surface of the photoconductor drum. The developing part is configured to transport toner to the surface of the photoconductor drum to visualize, by the toner, the electrostatic latent image carried by the photoconductor drum. The primary transfer unit is configured to primarily transfer a toner image formed on the photoconductor drum to the transfer belt. The secondary transfer part is configured to secondarily transfer, to a paper sheet, the toner image primarily transferred to the transfer belt. The fixing unit is configured to fix the toner image transferred to the paper sheet. The paper sheet discharging unit is configured to discharge the paper sheet on which the toner is fixed. The transporting unit is configured to transport the paper sheet. Note that the developing part includes a toner bottle that contains the toner and a sub hopper that can store a certain amount of the toner. The toner is conveyed from the toner bottle to the sub hopper, and the toner is transported from the sub hopper to the surface of the photoconductor drum via a developing roller. Then, when the toner remaining amount in the sub hopper becomes small, the toner is supplied to the sub hopper from the toner bottle.

The image reading part (ICCU) 41 is a part configured to perform an inspection, calibration, and the like on the image formed by the image forming part 40, and includes a sensor configured to read an image (for example, an in-line scanner provided in a paper sheet transport path between the fixing unit and the paper sheet discharging unit of the above image forming part 40). This in-line scanner includes, for example, three types of sensors of red (R), green (G), and blue (B), and is configured to detect a RGB value according to a light amount of light reflected on the paper sheet to acquire the read image.

Note that FIGS. 1 to 4B are an example of the control system 10 of the present embodiment, and the configuration and control of each device can be changed as appropriate. For example, in FIG. 1, the control system 10 includes the machine learning device 20 and the image forming device 30, but the control system 10 may include a computer device of a development department or a sales company. The above computer device may receive an individual request of the user who uses the image forming device 30 and notify the machine learning device 20 of the individual request, and the machine learning device 20 may change product specifications according to the individual requirement.

Next, an outline of learning in the machine learning device 20 of the present embodiment will be described with reference to FIGS. 5 and 6. In the learning of the present embodiment, the first machine learning part 21b (generator) configured to determine control and the second machine learning part 21c (discriminator) configured to evaluate a control result are caused to learn adversarially, whereby the control parameter of image formation in the image forming device 30 is optimized.

Specifically, the generator is configured to receive the machine state and the comparison image as input, generate the control parameter of image formation by machine learning, and output the generated control parameter to the image forming device 30 (S101). The image forming part 40 of the image forming device 30 is configured to start printing according to the control parameter received from the generator (S102). At this time, operation similar to conventional print operation is performed except for the control parameter of image formation. For example, in transport control, the paper sheet is fed and transported at conventional timing. The image printed on the paper sheet is read again as the image data by the image reading part 41 located on a downstream side of the image forming part 40 (S103). Then, either of the read image obtained by reading the printed image or the comparison image used at the time of the printing is randomly input to the discriminator (S104), and the discriminator is configured to determine whether either of the read image or the comparison image has been input (S105). On the basis of on a determination result, the generator and/or the discriminator are caused to learn according to the tables of FIGS. 7A and 7B (S106).

FIG. 7A is a table that defines learning (reward) for the generator, and FIG. 7B is a table that defines learning for the discriminator. For example, when the read image is input to the discriminator, in a case where the determination result of the discriminator is correct (the discriminator has determined that the input image is the read image), the generator is given −1 as a reward because the generator could not make the read image similar to the comparison image, and the discriminator is regarded as giving a correct answer and caused to learn. Furthermore, when the read image is input to the discriminator, in a case where the determination result of the discriminator is incorrect (the discriminator has determined that the input image is the comparison image), the generator is given +1 as a reward because the generator could make the read image similar to the comparison image, and the discriminator is regarded as giving an incorrect answer and caused to learn. Furthermore, when the comparison image is input to the discriminator, in a case where the determination result of the discriminator is correct (the discriminator has determined that the input image is the comparison image), the generator receives nothing (is not given a reward) because the generator is not involved in the creation of the comparison image, and the discriminator is regarded as giving a correct answer and caused to learn. Furthermore, When the comparison image is input to the discriminator, in a case where the determination result of the discriminator is incorrect (the discriminator has determined that the input image is the read image), the generator receives nothing (is not given a reward) because the generators is not involved in the creation of the comparison image, and the discriminator is regarded as giving an incorrect answer and caused to learn. That is, the above processing means causing the generator to learn so that the generator makes the read image similar to the comparison image until the read image and the comparison images become indistinguishable from each other.

Note that when the discriminator has already learned with a teacher (using a set of the comparison image and the read image) in advance, learning efficiency can be improved. Therefore, as the comparison image, a test image used in advance at the development stage can be used.

Furthermore, the reinforcement learning is used for the generator. There are various forms of this reinforcement learning. For example, a case of using deep q-network (DQN) that is reinforcement learning using a neural network (NN) as shown in FIG. 8 will be described. In the DQN, learning is performed by using an input layer of the NN as the machine state (for example, a deterioration state of the transfer belt) and using an output layer as the control parameter of image formation (for example, the developing voltage). The discriminator is configured to evaluate a result of causing a main body to operate according to the control parameter determined by the NN, and determine a reward. An error (see the formula in the figure) is calculated from the determined reward, and the weighting of each layer of the NN is updated by reflecting the error in the NN by backpropagation (error backpropagation method).

Next, an example in which the control parameter of image formation is actually generated, by the reinforcement learning will be shown. FIG. 9 shows an outline of the image forming part 40. The toner bottle is rotated by the toner bottle motor, whereby the toner contained in the toner bottle (TB) is transported to the sub hopper in the developing part. Then, a screw of the sub hopper is rotated, whereby the toner is applied to the developing roller. The photoconductor is charged by the charging unit (−600 V in the figure below), and the photoconductor is exposed by the exposing unit, whereby an absolute value of potential at a point where the toner is desired to be attached (the exposing unit in the figure) is decreased (−700 V to −50 V in the figure below). The toner attached to the developing roller is charged by the developing voltage, and due to a potential difference between the toner and the exposing unit of the photoconductor, the toner is attached to the photoconductor. At this time, the light and shade of the image can be controlled by this potential difference.

Therefore, output from the generator can be the developing voltage as a control parameter that controls the image density. Furthermore, the input to the generator is the comparison image, whereby it is possible to make the generator output a required developing voltage from a required image density. In that case, as shown in FIG. 10, the generator is configured to detect the required image density by analyzing the comparison image (S201), and specify and output the required developing voltage on the basis of the relationship between the image density and the potential difference shown in FIG. 11A (S202).

This image density can be controlled by the potential difference, but also influences other parameters. For example, as shown in FIG. 11B, when the toner remaining amount in the sub hopper becomes small, an amount of the toner attached to the developing roller cannot be increased even if the potential difference is increased, and a result, the image becomes light. In this case, output from the generator is the developing voltage and toner bottle motor output (the number of rotations), and input to the generator is the comparison image and the sub-hopper toner remaining amount. In that case, as shown in FIG. 12, the generator is configured to determine Whether the sub-hopper toner remaining amount is less than a predetermined value (S301), and when the sub-hopper toner remaining amount is less than the predetermined value (Yes in S301), the toner bottle motor is rotated (S302). Then, when the toner becomes sufficiently stored in the sub hopper (No in S301), the comparison image is analyzed to detect the required image density (S303), and the required developing voltage is specified and output on the basis of the relationship between the image density and the potential difference shown in FIG. 11A (S304).

As described above, all the parameters that may influence the image quality are input and all the control parameters of image formation are output, whereby it becomes possible to learn control corresponding to every phenomenon. For example, as shown in FIG. 13, as the parameters that may influence the image quality, the surface state of the transfer belt, the film thickness of the photoconductor, the degree of deterioration of the developing part, the degree of dirt of the secondary transfer part, and the toner remaining amount, the sub-hopper toner remaining amount, the in-device temperature, the in-device humidity, the basis weight of the paper sheet, the surface roughness of the paper sheet, and the like are input. As the control parameters of image formation, the developing voltage, the charging voltage, the exposure light amount, the toner bottle motor output, and the like are output. Then, learning can be performed.

Hereinafter, the machine learning method in the machine learning device 20 of the present embodiment will be described. The CPU 22 of the control part 21 of the machine learning device 20 is configured to expand the machine learning program stored in the ROM 23 or the storage unit 25 into the RAM 24 and execute the machine learning program, thereby executing the processing of each step shown in the flowcharts of FIGS. 14 to 18. Note that it is preferable that the learning of the generator and the discriminator is performed after the printing is performed on a predetermined number of paper sheets or when the machine state of the image forming device 30 changes by a predetermined value or more.

As shown in FIG. 14, When the machine state and the comparison image are input to the generator (S401), the generator is configured to output the control parameter of image formation (S102). Next, the image forming part 40 is configured to control the printing on the basis of the control parameter generated by the generator (S403). In a case where a jam has occurred as a result of the printing by the image forming part 40 (Yes in S404), a reward−1 is given to the generator (S405), and the processing returns to S401.

Meanwhile, in a case where a jam has not occurred (No in S404), the image reading part 41 is configured to read the printed matter (S406), and one of the read image read in S406 and the comparison image input in S401 is randomly input to the discriminator (S407).

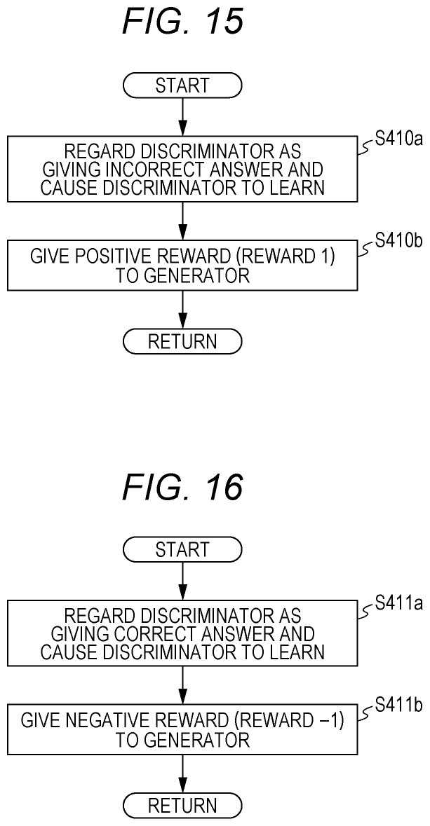

In a case where the input image is the read image, it is determined whether the discriminator has erroneously recognized (S409), and in a case where the discriminator has erroneously recognized (determined that the input image is the comparison image) (Yes in S409), the first learning control is performed (S410). Specifically, as shown in FIG. 15, the discriminator is regarded as giving an incorrect answer and caused to learn (S410a), and the generator is given a positive reward (for example, reward 1) (S410(b). Furthermore, in a case where the discriminator has not erroneously recognized (determined that the input image is the read image) (No in S409), the second learning control is performed (S411). Specifically, as shown in FIG. 16, the discriminator is regarded as giving a correct answer and caused to learn (S411a), and the discriminator is given a negative reward (for example, reward−1) (S411b).

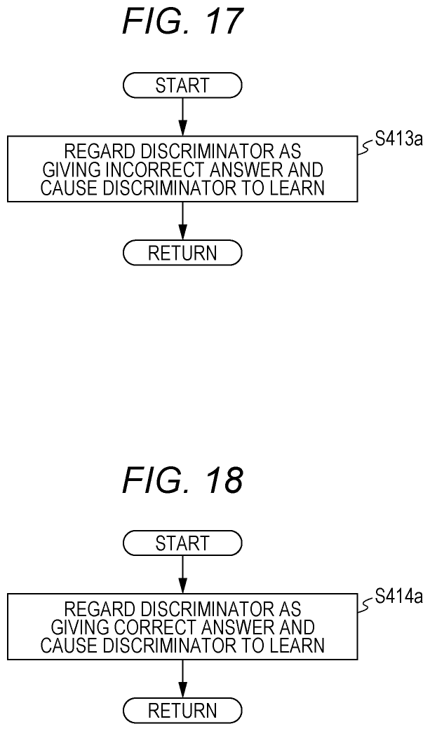

Furthermore, in a case where the input image is the comparison image, it is determined whether the discriminator has erroneously recognized (S412), and in a case where the discriminator has erroneously recognized (determined that the input image is the read image) (Yes in S412), the third learning control is performed (S413). Specifically, as shown in FIG. 17, the discriminator is regarded as giving an incorrect answer and caused to learn (S413a). Furthermore, in a case where the discriminator has not erroneously recognized (determined that the input image is the comparison image) (No in S412), the fourth learning control is performed (S414). Specifically, as shown in FIG. 18, the discriminator is regarded as giving a correct answer and caused to learn (S414a).

After that, it is determined Whether the number of times the discriminator has erroneously recognized (especially, the number of times the read image is input to the discriminator and the discriminator has erroneously recognized that the input image is the comparison image) reaches a predetermined number of times or more (S415). When the number of times the discriminator has erroneously recognized is not the predetermined number of times or more (No in S415), the processing returns to S401 to continue learning. Meanwhile, in a case where the number of times the discriminator erroneously recognized reaches the predetermined number of times or more (Yes in S415), the generator cannot be properly caused to learn by this learning method, and therefore the processing is terminated and the discriminator is caused to learn.

As described above, the reinforcement learning is applied to the generation of the control parameter of image formation, whereby it becomes possible to generate the control parameter according to each machine in the market, and to satisfy the requirement of the user who uses each machine.

Note that the present invention is not limited to the above embodiment, and the configuration and control of the embodiment can be appropriately changed without departing from the spirit of the present invention.

For example, in the above embodiment, a case where the machine learning method of the present invention is applied to the image forming device 30 has been described, but the machine learning method of the present invention is applied similarly to any device that performs control according to a control parameter.

The present invention is applicable to a machine learning device configured to generate a control parameter of image formation in an image forming device, a machine learning method, a machine learning program, and a recording medium in which the machine learning program is recorded.

Although embodiments of the present invention have been described and illustrated in detail, the disclosed embodiments are made for purposes of illustration and example only and not limitation. The scope of the present invention should be interpreted by terms of the appended claims.

What is claimed is:

1. A machine learning device that generates a control parameter of image formation in an image forming device including an image forming part that forms an image on a paper sheet and an image reading part that reads the image formed on the paper sheet, the machine learning device comprising:
a first hardware processor that generates the control parameter on the basis of machine learning;
a second hardware processor that receives input of an image including a read image that is formed by the image forming part according to the control parameter and read by the image reading part, the second hardware processor making a determination relating to the read image on the basis of machine learning; and
a third hardware processor that causes the first hardware processor and/or the second hardware processor to learn on the basis of a determination result by the second hardware processor.

2. The machine learning device according to claim 2, wherein the third hardware processor randomly inputs either one of the read image and a comparison image prepared in advance to the second hardware processor, and the second hardware processor determines whether the input image is either the read image or the comparison image on the basis of machine learning.

3. The machine learning device according to claim 2, wherein when the read image is input to the second hardware processor, in a case where the second hardware processor has determined that the input image is the read image, the third hardware processor gives a negative reward to the first hardware processor, regards the second hardware processor as giving a correct answer, and, causes the second hardware processor to learn.

4. The machine learning device according to claim 2, wherein when the read image is input to the second hardware processor, in a case where the second hardware processor has determined that the input image is the comparison image, the third hardware processor gives a positive reward to the first hardware processor, regards the second hardware processor as giving an incorrect answer, and causes the second hardware processor to learn.

5. The machine learning device according to claim 2, wherein when the comparison image is input to the second hardware processor, in a case where the second hardware processor has determined that the input image is the comparison image, the third hardware processor does not give a reward to the first hardware processor, regards the second hardware processor as giving a correct answer, and causes the second hardware processor to learn.

6. The machine learning device according to claim 2, wherein when the comparison image is input to the second hardware processor, in a case where the second hardware processor has determined that the input image is the read image, the third hardware processor does not give a reward to the first hardware processor, regards the second hardware processor as giving an incorrect answer, and causes the second hardware processor to learn.

7. The machine learning device according to claim 2, wherein after printing is performed on a predetermined number of paper sheets or when a machine state of the image forming device changes by a predetermined value or more, the third, hardware processor causes the first hardware processor and/or the second hardware processor to learn.

8. The machine learning device according to claim 2, wherein in a case where the read image is input to the second hardware processor, when the number of times the second hardware processor has determined that the input image is the comparison image reaches a predetermined number of times or more, the third hardware processor terminates learning of the first hardware processor and/or the second hardware processor.

9. The machine learning device according to claim 2, wherein the first hardware processor receives input of the machine state of the image forming device and/or the comparison image.

10. The machine learning device according to claim 9, wherein the first hardware processor receives input of at least one of a surface state of a transfer belt, a film thickness of a photoconductor, a degree of deterioration of a developing part, a degree of dirt in a secondary transfer part, a toner remaining amount, a sub-hopper toner remaining amount, in-device temperature, in-device humidity, a basis weight of a paper sheet, and surface roughness of the paper sheet as the machine state of the image forming device.

11. The machine learning device according to claim 9, wherein in a case where the first hardware processor receives input of the comparison image, the first hardware processor generates the control parameter by reinforcement learning using a neural network, and in a case where the first hardware processor receives input of the machine state of the image forming device, the first hardware processor generates the control parameter by reinforcement learning using a convolutional neural network.

12. The machine learning device according to claim 1, wherein the first hardware processor, as the control parameter, outputs at least one of a developing voltage, a charging voltage, an exposure light amount, and the number of rotations of a toner bottle motor.

13. The machine learning device according to claim 1, wherein the second hardware processor performs image distinction using deep learning.

14. The machine learning device according to claim 1, wherein the machine learning device exists on a cloud server.

15. The machine learning device according to claim 1, wherein the machine learning device is built in the image forming device or a control device that controls the image forming device.

16. A machine learning method that generates a control parameter of image formation in an image forming device including an image forming part that forms an image on a paper sheet and an image reading part that reads the image formed on the paper sheet, the machine learning method executing:
generating the control parameter on the image forming device, a control device that controls the image forming device, or a cloud server on the basis of machine learning;
inputting an image including a read image that is formed by the image forming part according to the control parameter and read by the image reading part and making a determination relating to the read image on the basis of machine learning; and
learning the generating and/or the inputting on the basis of a determination result of the inputting.

17. A non-transitory recording medium storing a computer readable machine learning program that generates a control parameter of image formation in an image forming device including an image forming part that forms an image on a paper sheet and an image reading part that reads time image formed on the paper sheet, the program causing a hardware processor of the image forming device, a control device that controls the image forming device, or a cloud server to execute:
generating the control parameter on the basis of machine learning;
inputting an image including a read image that is formed by the image forming part according to the control parameter and read by the image reading part and making a determination relating to the read image on the basis of machine learning; and
learning the generating and/or the inputting on the basis of a determination result of the inputting.
